(19) United States
(12) Patent Application Publication
(10) Pub. No.: US 2008/0313356 A1
(43) Pub. Date: Dec. 18, 2008

(54) REMOTE CONTROL OF DEVICES THROUGH INSTANT MESSENGER

(75) Inventors: ARNOLD N. BLINN, BELLEVUE, WA (US); DON GILLETT, BELLEVUE, WA (US); DANIEL A. ROSENFELD, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/763,903

(22) Filed: Jun. 15, 2007

(51) Int. Cl. G06F 3/00

(52) U.S. Cl. 710/7

(57) ABSTRACT

Computerized methods and systems for controlling a peripheral device based, at least in part, upon remote user instructions are provided. Upon receiving a communication from the peripheral device (e.g., using a USB port), a computing device recognizes the peripheral device. Next, a command manifest is automatically generated that includes one or more commands that correspond to at least one controllable function of the peripheral device. In addition, the command manifest may be communicated to a remote-user device configured to present the commands to the remote user, typically, by displaying a representation of the commands at a user interface associated therewith. A transmission that includes content indicating one or more of the commands may be received from the remote-user device. Consequently, commands are determined from content and transferred to the peripheral device, which performs the corresponding controllable functions.

### BACKGROUND

The Internet provides a platform for the distribution of information and data. Increasingly, applications that utilize the network of the Internet have been developed to allow users to communicate via text, video, and audio messaging. For instance, web sites allow users to obtain live-action media that can be streamed throughout the Internet to computing devices associated therewith. In addition, instant-messaging applications, which permit people to communicate with each other over the Internet in real time, have become increasingly popular. These applications not only allow users to communicate over a new medium, but also provide enjoyable group interactions.

In order to further enhance interest and excitement for computer users, a peripheral device may be used. Utilization of peripheral devices that connect to a computing device is increasingly popular, and can provide the user with task-orientated or entertaining functions. Typically, these devices may be controlled by an interface on the computing device. For instance, an automated mechanical robot that is connected to a universal serial bus (USB) port of a computer may be controlled by the local user of that computer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to remotely controlling peripheral computing devices through an instant messaging application. Upon receiving a communication from the peripheral device, the computing device recognizes the peripheral device (e.g., a remote-control web camera that adjusts, an automated robot that produces sound, or a unit that emits light). In one embodiment, the command manifest is installed in the device as a driver file. In another embodiment, the command manifest is automatically generated upon such recognition that includes one or more commands that correspond to the controllable functions of the recognized peripheral device (e.g., commands that pan, tilt, and focus the remote-control web camera; commands that chirp, beep, or blink an electronic toy). The command manifest may include commands and one or more user-interface layouts that present a representation of the commands to a user (e.g., listing of commands, graphical display using icons to represent commands). The command manifest may be communicated to the remote-user device. Next, instructions may be received from the remote-user device pertaining to control of one or more of the commands included in the command manifest. The instructions may then be transferred to the peripheral device, which may execute the corresponding controllable functions (e.g., causing the remote-control web camera to tilt up and pan right).

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system suitable for use in implementing embodiments of the present invention;

FIG. 3 is a flow diagram showing a method for providing control of a peripheral device on a computing device by a remote user, in accordance with an embodiment of the present invention;

FIG. 4 is a flow diagram showing a method for automatically generating a command manifest, in accordance with an embodiment of the present invention;

FIG. 5 is a flow diagram showing a method for receiving an indication of a command over an instant-messaging application, in accordance with an embodiment of the present invention;

FIG. 6 is a flow diagram showing a method for receiving an indication of a command from a web server embedded on the computing device, in accordance with an embodiment of the present invention;

FIG. 7 is an exemplary screen display of an exemplary user interface wherein correspondence from the remote-user device is provided using an instant-messaging application; and

FIG. 8 is an exemplary screen display of an exemplary user interface wherein transmission from the remote-user device is provided to a web server embedded in the computing device.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, systems, and computer-readable media having computer-executable instructions embodied thereon that, when executed, perform methods in accordance with embodiments hereof, for permitting remote control of peripheral devices associated with a computing device. Upon receiving a communication from the peripheral device, the computing device recognizes the peripheral device (e.g., a remote-control web camera that adjusts, an automated robot that produces sound, or a unit that emits light). In one instance, the peripheral device communicates with the computing device via a universal serial bus (USB) port. In one embodiment, the command manifest is installed in the device as a driver file. In another embodiment, the command manifest is automatically generated upon such recognition that includes one or more commands that correspond to the controllable functions of the recognized peripheral device (e.g., commands that pan, tilt, and focus the remote-control web camera; commands that chirp, beep, or blink an electronic toy). The command manifest may include commands and one or more user-interface layouts that present a representation of the commands to a user (e.g., listing of commands, graphical display using icons to represent commands). The command manifest may be communicated to the remote-user device. Next, a transmission is received from the remote-user device, that includes content indicative of one or more of the commands included in the command manifest. The commands are then transferred to the peripheral device, which executes the corresponding controllable functions (e.g., causing the remote-control web camera to tilt up and pan right).

Accordingly, in one aspect, embodiments of the present invention relate to one or more computer-readable media having computer-executable instructions embodied thereon that, when executed, perform a method for remotely controlling one or more peripheral devices associated with a computing device. The method includes receiving a communication from a peripheral device; automatically generating a command manifest associated with the peripheral device, wherein the command manifest includes one or more commands each corresponding to at least one controllable function of the peripheral device; and communicating the command manifest to a remote-user device.

In another aspect, embodiments of the present invention relate to a computer system for providing remote user control of a peripheral device. The computer system includes a peripheral device detecting module, a command manifest generating module, and a command communicating module. The peripheral device detecting module is configured to receive communications from a plurality of peripheral devices and to determine if received communications are associated with a recognized peripheral device. The command manifest generating module is configured to automatically generate a command manifest associated with any recognized peripheral device, the command manifest including one or more commands each corresponding to at least one controllable function of the peripheral device. The command communicating module is configured to communicate the command manifest (e.g., to a remote-user device or to the local user of the computing device) to allow for presentation and execution of one or more commands therein.

In yet another aspect, embodiments of the present invention relate to one or more computer-readable storage media having computer-executable instructions embodied thereon that, when executed, perform a method for presenting a user interface on a remote control device, the user interface for controlling one or more functions of a peripheral device in communication with a computing device. The computer-readable storage media comprises code for recognizing the peripheral device at the computing device, and code for automatically generating a command manifest associated with the recognized peripheral device. Further, the computer-readable storage media comprises code for communicating the command manifest to a remote-user device, where the remote-user device is configured to present the one or more commands to a remote user.

Having briefly described an overview of embodiments of the present invention, an exemplary operating environment suitable for implementing the present invention is described below.

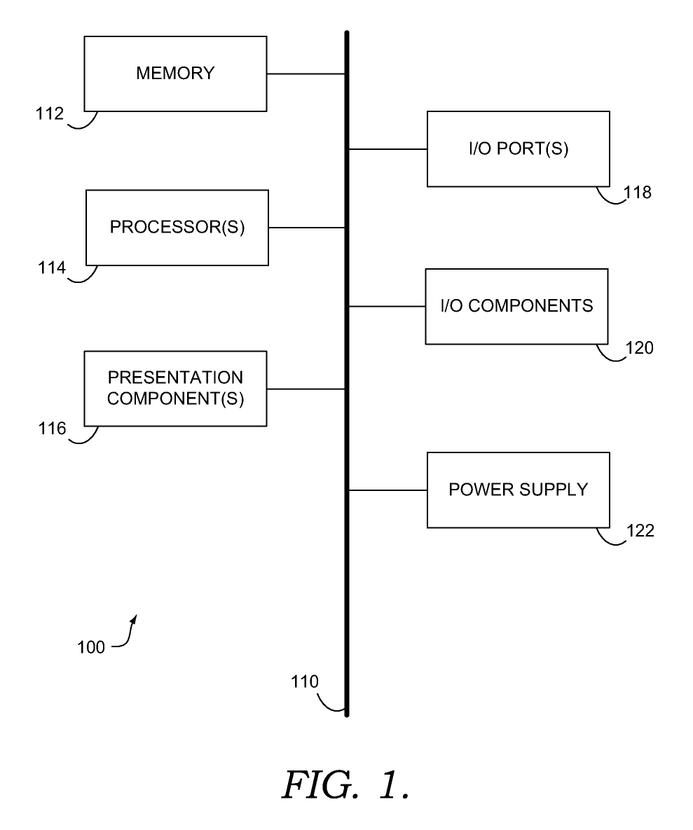

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

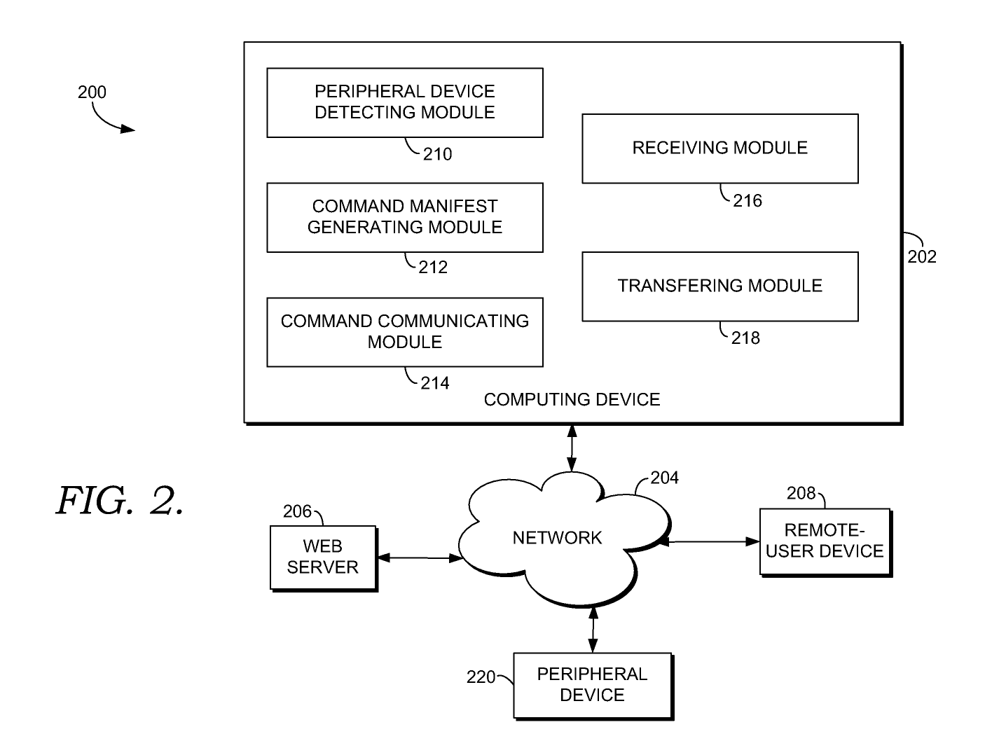

Turning now to FIG. 2, a block diagram is illustrated, in accordance with an embodiment of the present invention, that shows an exemplary computing system 200 configured to provide control of a peripheral device associated with a computing device, at least in part, by a remote user. It will be understood and appreciated by those of ordinary skill in the art that the computing system 200 shown in FIG. 2 is merely an example of one suitable computing system environment and is not intended to suggest any limitation as to the scope of use or functionality of embodiments of the present invention. Neither should the computing system 200 be interpreted as having any dependency or requirement related to any single component/module or combination of components/modules illustrated therein.

The computing system 200 includes a web server 206, a computing device 202, a remote-user device 208, and a peripheral device 220, all in communication with one another via a network 204. The network 204 may include, without limitation, one or more local area networks (LANs) and/or wide area networks (WANs). Such networking environments are commonplace in offices, enterprise-wide computer networks, intranets, and the Internet. Accordingly, the network 204 is not further described herein.

Each of the web server 206, the remote-user device 208, and the computing device 202 shown in FIG. 2 may be any type of computing device, such as, for example, computing device 100 described above with reference to FIG. 1. By way of example only and not limitation, the web server 206, the remote-user device 208, and/or the computing device 202 may be a personal computer, desktop computer, laptop computer, handheld device, mobile handset, consumer electronic device, and the like. Additionally, the remote-user device 208 may further include a keyboard, keypad, stylus, joystick, and any other input-initiating component that provides wired or wireless data to the network 204. It should be noted, however, that the present invention is not limited to implementation on such computing devices, but may be implemented on any of a variety of different types of computing devices within the scope of embodiments hereof.

The web server 206 is configured to render a representation of one or more commands at a user interface based upon a determination of whether the remote-user device 208 is registered as an authorized user at the computing device 202. Upon receiving an indication that access to the web server 206 is available, the commands may then be communicated to the user interface. In one embodiment, the web server 206 is a stand-alone entity as depicted in FIG. 2, having a client-server relationship with the computing device 202. In another embodiment, as is well-known in the art, the web server 206 may be embedded on the computing device 202. That is, any application(s) and/or database(s) that are associated with the web server 206, in accordance with the scope of the present invention, may reside within the computing device 202.

The peripheral device 220 may be a stand-alone device or may be partially integrated with the computing device 202. Typically, the peripheral device 220 is a device that may communicate with the computing device 202 by wired or wireless channels. In one embodiment, the peripheral device 220 communicates via a connection with the computing device 202 at a universal serial bus (USB) port. In another embodiment, the peripheral device 220 may communicate via a wireless personal area network (PAN) (e.g., a Bluetooth™ connection that exchanges information between devices such as mobile phones, laptops, PCs, printers, digital cameras, and video game consoles over a secure, globally unlicensed short-range radio frequency, LAN, WAN). Further, the peripheral device 220 may perform particular functions (e.g., produce light, provide movement, emit sound, etc.). These functions may be task-orientated and useful (e.g., desk fan), or simply for the purpose of entertainment (e.g., USB missile launcher). For instance, the peripheral device 220 may be a mechanical toy that responds to commands with motion (e.g., gestures) thereby expressing the command visually in physical space. Although several embodiments are depicted hereinabove, one of ordinary skill in the art will understand and appreciate that peripheral devices encompass a broad range of devices that communicate directly or indirectly with a computing device and that any and all such devices are contemplated to be within the scope of embodiments hereof.

As shown in FIG. 2, the computing device 202 includes a peripheral device detecting module 210, a command manifest generating module 212, a command communicating module 214, a receiving module 216, and a transferring module 218. In some embodiments, one or more of the illustrated modules 210, 212, 214, 216, and 218 may be implemented as stand-alone applications. In other embodiments, one or more of the illustrated modules 210, 212, 214, 216, and 218 may be integrated directly into the operating system of the web server 206 or the remote-user device 208. By way of example only, the receiving module 216 may be housed in association with the remote-user device 208, while the peripheral device detecting module 210 may be housed in association with the peripheral device 220. In the instance of multiple web servers, embodiments of the present invention contemplate providing a load balancer to federate incoming transmissions/instructions from the remote-device(s) 208. It will be understood by those of ordinary skill in the art that the modules 210, 212, 214, 216, and 218 illustrated in FIG. 2 are exemplary in nature and in number and should not be construed as limiting. Any number of modules may be employed to achieve the desired functionality within the scope of embodiments of the present invention.

The peripheral device detecting module 210 is configured to receive communications from a plurality of peripheral devices and to determine if received communications are associated with a recognized peripheral device. Initially, the peripheral device is connected to the computing device by a wired (e.g., USB port), or a wireless (e.g., Bluetooth™) interface. Although two embodiments are depicted, the present invention contemplates any other interfaces and protocols that establish peripheral device-computing device communication. Incident upon establishing communication, the computing device may recognize, or identify, the peripheral device. More specifically, the computing device becomes aware of the communicating peripheral device and the functions that is can perform. The terms “functions” and “controllable functions,” as used herein, are not meant to limiting and are utilized to indicate any action, production of light/sound, or adjustment that is directly or indirectly controlled by the computing device.

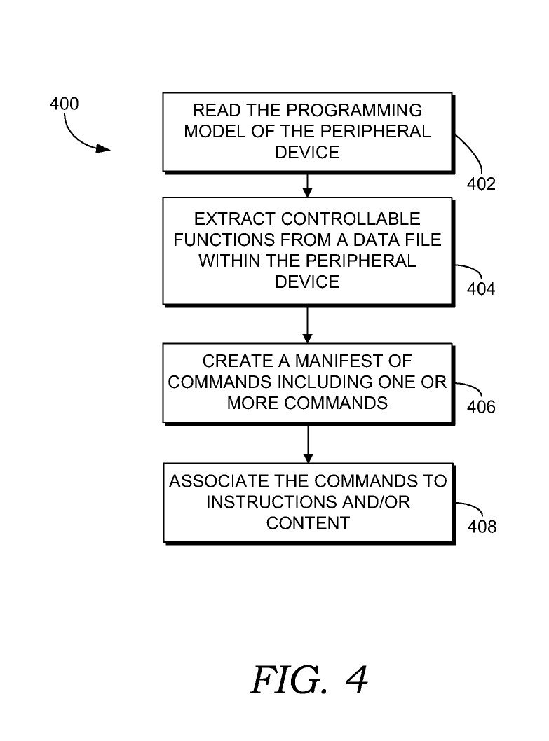

The command manifest generating module 212 is configured to automatically generate a command manifest associated with the recognized peripheral device. As such, the interactive functionality of the peripheral device is integrated into the computing device having control capability thereover. In one embodiment, integration is achieved by a device-driver abstraction layer that reads a programming model from a peripheral device and maps the controllable functions to one or more commands corresponding thereto (more fully discussed below with reference to FIG. 4).

By way of example only, reading the programming model may be performed by an application associated with the computing device or by software loaded onto the computing device with function recognition capabilities. The programming model typically includes the controllable functions that the peripheral device supports, and may be extracted from a data file within the peripheral device. In some embodiments, the programming model may further include instructions related to rendering the controllable functions on a user interface as representations of commands. As a result, the controllable functions may be exposed to a local user of the computing device or to other remote users at remote-user devices so that remote control may be exerted over the peripheral device.

In another embodiment of the present invention, the manifest of commands are embedded in, or uploaded to, the computing device with an association to a particular peripheral device stored therewith. That is, upon recognizing communication has been initiated with a peripheral device, the computing device will access the associated manifest of commands from a memory file. In this embodiment, the command manifest generating module 212 is optional.

Next, by way of example only, mapping the controllable functions comprises creating a command manifest comprising one or more commands that correspond to one or more controllable functions of the peripheral device. Further, mapping enables these commands to be triggered by certain content or instructions received in a transmission from the peripheral device. That is, commands are associated with particular instructions (e.g., mouse-clicking a displayed “fire” icon), content (e.g., terms typed at an instant-messaging application cause a reaction), or input from remote-user devices including keystrokes from keyboards, certain movement from joysticks, indications from touch-screens and/or control panels, and the like. Consequently, content, instructions, or other user input may control the corresponding controllable functions of the peripheral device.

The command communicating module 214 is configured to communicate the command manifest, for instance, to a remote-user device configured to present a representation of the one or more commands to a remote user. It will be understood by those of ordinary skill in the art that communication may be made by any form of data transfer used to transmit information over an internet, intranet, network, and the like. For instance, communicating the command manifest may be achieved by a format readable by an instant-messaging application. In another instance, the command manifest may be communicated from an embedded web server that resides on the computing device. As a result, remote users on the network are allowed to interactively control the peripheral devices by responding to the representation of the commands with instructions. As more fully discussed below, permission may be required to interactively control the peripheral devices, at the option of the local user. Providing permission may vary based on the method of communicating the command (e.g., web servers authenticate the remote-user, Instant Messenger requires membership on a buddy list and/or access settings). Alternatively, the representation of commands may not be presented; yet, content in a transmission from a remote-user device may passively indicate (i.e., without express instruction from a remote user) one or more commands that control the peripheral device.

In one embodiment, wherein a representation of commands are displayed, remote users may utilize remote-user devices (e.g., micro-processor-controlled devices) that render, or display, an interface, which may include a graphical user interface (GUI), database or scripting interface, menu driven interface, etc., that is collectively referred to herein as a user interface (UI). Additionally, the user interface can send data (e.g., content and/or instructions) that triggers commands that can be transferred to the peripheral device, as more fully discussed below with reference to the transferring module 218.

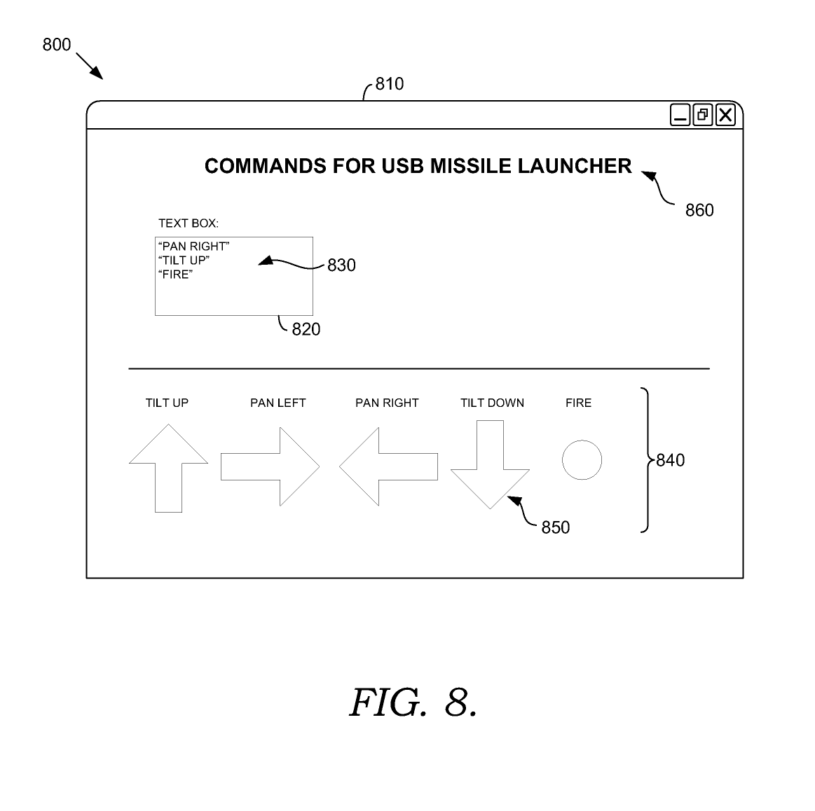

By way of example only, the user interface may be configured to present a representation of commands and/or receive instructions according more than one peripheral device. For instance, the user interface may include a control area (more fully discussed below with reference to FIG. 8) for operating a remote-control web camera that displays images at the remote-user device user interface, and a control area for operating a USB missile launcher. As such, the remote user may take advantage of the images transmitted from the remote-control web camera in aiming the USB missile launcher prior to firing.

The receiving module 216 is configured to receive a transmission from the remote-user device, wherein content or instructions included in the transmission indicate one or more commands of the command manifest. Transmission from a remote-user device may be made by any method know by those of ordinary skill in the art, and those methods are contemplated by the present invention. Indication may be by an application typically on the computing device that is operative to interpret and extract one or more commands by utilizing the content or instructions associated therewith.

In one embodiment, the application interprets an instant-messaging application correspondence, typically intended for communication between humans sending messages, so that it may be utilized by a peripheral device. Instant-messaging applications permit users to communicate with each other over the Internet in real time by providing channels for communication using multiple forms of media, including text, audio, pictures, video, and the like. Although text-based input from a remote user is discussed hereinbelow, it should be understood and appreciated by those of ordinary skill in the art that all other forms of media are contemplated by the present invention as sources of input for generating content within the transmission. Accordingly, a remote user with access to an instant-messaging application (e.g., Instant Messenger) can control a peripheral device to follow certain instructions (e.g., directing an automated robot to speak).

In one instance, the instant-messaging application sends, within the transmission, content that may indicate one or more commands of the command manifest. That is, a device layer may define commands that the content passively triggers such that a controllable function is provided by the remote user. By way of example only, the term or symbol “ [symbol] ” may be preconfigured by the device layer employed as the command manifest generating module 212 to automatically trigger a function of the peripheral device (e.g., causing a USB robotic dog to wag its tail). Triggering the controllable function may include comparing the content to pre-identified content that is generated by the command manifest generating module 212, discussed hereinabove. If matching pre-identified content (e.g., text) is found, the associated command is selected and transferred, and the function corresponding thereto is performed by the peripheral device. It should be understood, however, that the instant-messaging application may also render the a representation of commands to which the remote user may actively respond.

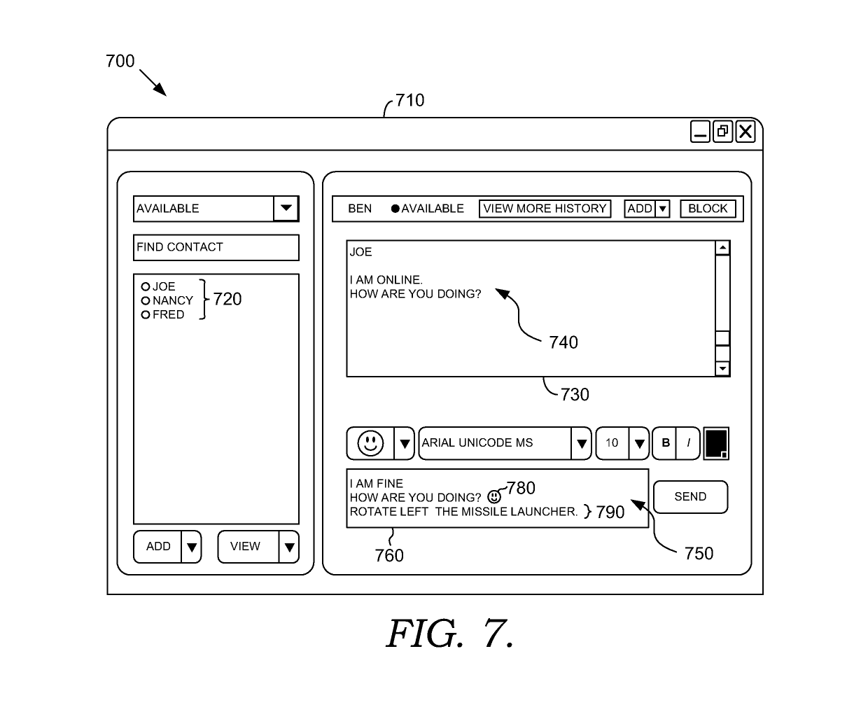

In another instance, the instant-messaging application includes access control. Here, a level of security is provided to ensure only certain selected remote users may control the peripheral device. More specifically, a level of access control of the computing device is provided by the instant messaging application that limits uninvited remote users from controlling the functions of the peripheral device (i.e., the computing device is instructed to accept communications from only certain pre-specified remote users). Thus, in order to provide content, the remote-user device must have the required instant messaging software installed and be identified as a member of a group (e.g., “buddy list”) that has permissive rights on the computing device. The buddy list can be created by the local user by identifying the various remote users with whom s/he wishes to communicate and have access to the peripheral device. Alternatively, remote user(s) may ask the local user for permission to control the peripheral device, and if granted, the remote user(s) is given permission to access the peripheral device through the embodiments above and through additional access control mechanism that are understood and appreciated by those of ordinary skill in the art. By way of example, a communication with a “buddy” can be started by simply double-clicking the buddy name corresponding to one or more remote users (more fully discussed below with reference to FIG. 7). The buddy name may be a user ID of the buddy, a nickname assigned to the buddy by the local user, and the like. As such, in this embodiment, the local user may allow control to one or more of the following: all users, only “buddies,” particular users within the “buddy list,” or specific “buddies” in the context of a conversation.

In another embodiment, the transmission includes specific instructions from the remote user, based on one or more presented representation of the commands, for controlling the peripheral device. An application on the computing device may then interpret these instructions received from a remote-user device and determines the one or more commands that are indicated by the instructions.

In this embodiment, typically, security is provided by a web server. In one instance, the web server may be website hosted by the computing device that provides remote access to the infrastructure thereof. Alternatively, the local user, or third-party security administrator, can configure the embedded web server such that remote users may not be afforded access the web server, and as such, denied the ability to control the peripheral device. In one instance, by way of example only, the receiving module 216 will initially determine whether a remote-user device is registered as an authorized user at the web server of the computing device. If the remote-user device is registered as an authorized user, access to the web server may then be provided and an indication to perform one or more commands of the command manifest (typically in the form of instructions) may be received at the web server.

By way of example only, a remote user may input a content or an instruction at the user interface associated with the remote-user device. As discussed above, the presented commands and the format of the user interface that renders the commands on the remote-user device may be generated and/or defined by the computing device. It will be understood and appreciated by those of ordinary skill in the art that multiple methods exist by which a remote user may input the content or instructions that are received by the receiving module 216. For instance, content or instructions may be input, by way of example only, utilizing a keyboard, joystick, trackball, touch-pad, or the like. In one embodiment, a user is provided a Web browser as the user interface display in which the user may input the content or instructions into an associated text box or control area. Alternative user interfaces known to those of ordinary skill in the art are contemplated to be included within embodiments of the invention.

The transferring module 218 is configured to transfer the one or more determined commands to the peripheral device. Transferring is performed by any method known by those of ordinary skill and/or discussed above (e.g., wire or wireless communication). Upon receiving the command(s), the peripheral device performs the corresponding one or more controllable functions according to the one or more determined commands. That is, upon conveying a command to the peripheral device, the peripheral device executes the command and causes the peripheral device to implement a corresponding function-thereby expressing the command visually in physical space.

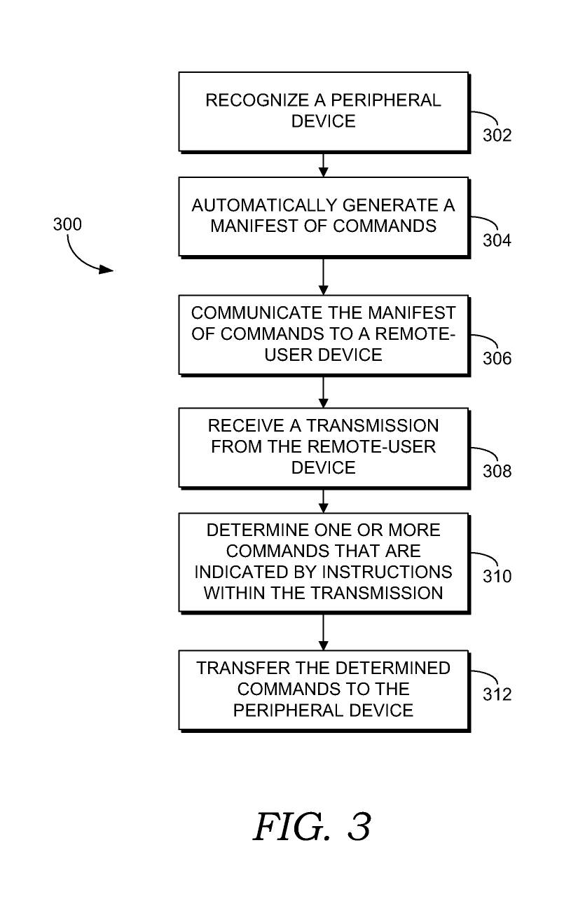

Turning now to FIG. 3, a flow diagram is illustrated that shows a method 300 for providing control of a peripheral device on a computing device by a remote user, in accordance with an embodiment of the present invention. Initially, as indicated at block 302, a peripheral device is recognized, for instance, by peripheral device detecting module 210 of FIG. 2. A command manifest is automatically generated, as indicated at block 304, e.g., utilizing command manifest generating module 212 of FIG. 2. Next, as indicated at block 306, the command manifest is communicated to a remote-user device, e.g., utilizing command communicating module 214 of FIG. 2. A transmission may be received from the remote-user device, and the one or more commands that are indicated by instructions within the transmission are determined, as indicated at block 310, e.g., utilizing receiving module 216 of FIG. 2. As indicated at block 312, the determined commands may be transferred to the peripheral device, for instance, by transferring module 218 of FIG. 2.

With reference to FIG. 4, a flow diagram is illustrated that shows a method 400 for automatically generating a command manifest, in accordance with an embodiment of the present invention. Initially, upon recognizing the peripheral device, the programming model of the peripheral device is read to determine the controllable functions thereof, as indicated at block 402. The controllable functions may then be extracted from a data file on the peripheral device, as indicated at block 404. Next, the command manifest is created, having one or more commands, where the commands are associated with content or instructions from the remote-user device, as indicated at blocks 406 and 408. Also, the format of, and representation of, the commands that are presented in the user interface may be extracted from the data file. Those of ordinary skill in the art will understand and appreciate the command manifest may also be received from an external source and/or accessed from a within the memory of the computing device.

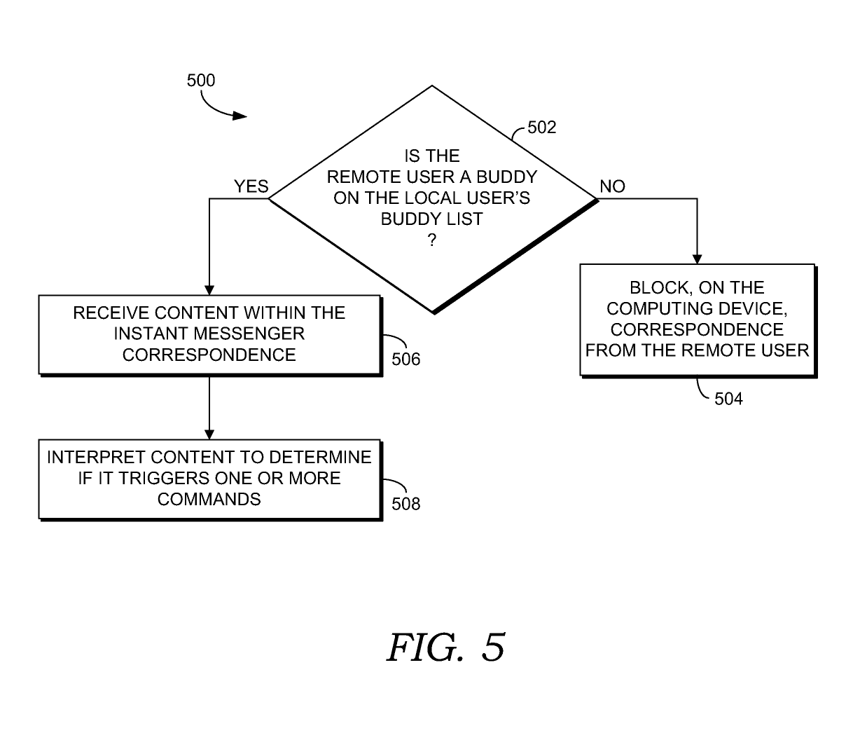

Turning now to FIG. 5, a flow diagram is illustrated that shows a method 500 for receiving an indication of a command over the instant-messaging application Instant Messenger, in accordance with an embodiment of the present invention. Initially a determination of whether the remote user is a buddy on the local user's buddy list is made. This is indicated at block 502. As indicated at block 504, if the remote user is not a buddy, the security measures within Instant Messenger on the computing device will block correspondence from the remote user, and as such, deny control of the peripheral device. Otherwise, if the remote user is a buddy on the local user's buddy list, the computing device will receive the Instant Messenger correspondence (block 506), and interpret the content of the correspondence (block 508) to determine if it triggers one or more commands. Although those on the buddy list are granted permission in this embodiment, the present invention contemplates access control over Instant Messenger by all means available (e.g., all users, only “buddies,” particular users within the “buddy list,” or specific “buddies” in the context of a conversation).

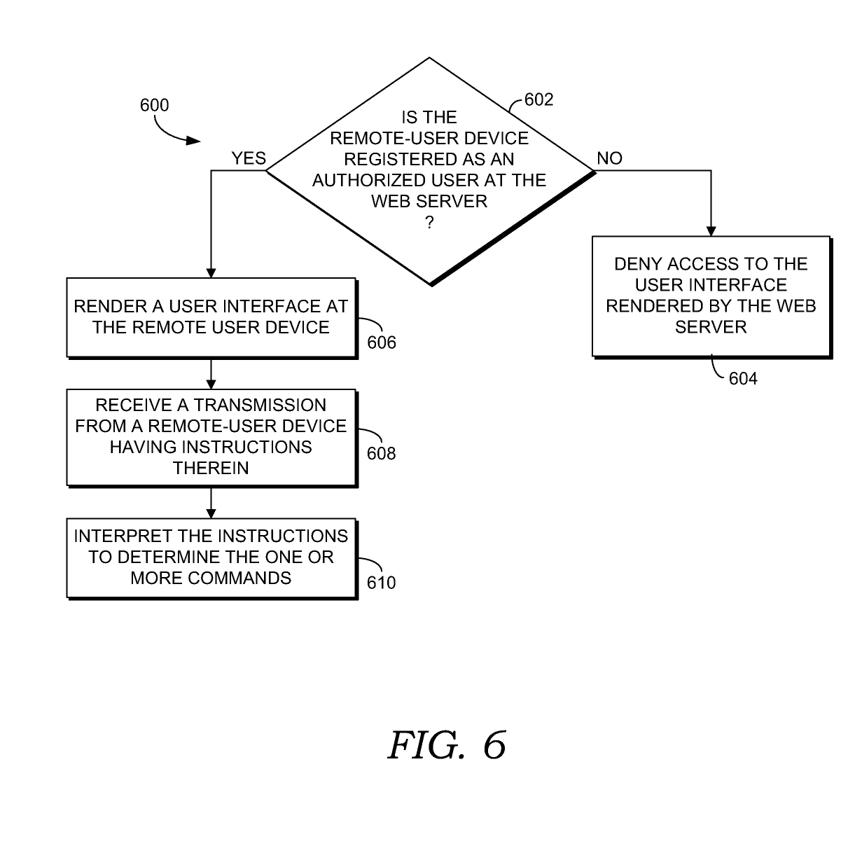

Turning now to FIG. 6, a flow diagram showing a method 600 for receiving an indication of a command from a web server embedded on the computing device, in accordance with an embodiment of the present invention, is shown. Initially, a determination of whether the remote-user device is registered as an authorized user of the web server is made. This is indicated at block 602. As indicated at block 604, if the remote-user device is not registered, access may then be denied to the user interface rendered by the web server. Otherwise, if the remote-user device is registered, a user interface is rendered at the remote-user device (e.g., generated by the web server), as indicated at block 606. By way of example only, this user interface may include a format and representation of commands as defined by the peripheral device. Typically, the user interface will present a representation of commands to the remote user. Next, a transmission from the remote-user device may be received having instructions therein, as indicated at block 608. As indicated at block 610, the instructions are interpreted to determine one or more corresponding commands indicated thereby.

Referring to FIG. 7, an illustrative screen display 700 of an exemplary user interface 710 is shown having a text box 730 for enabling correspondence from a remote-user device, in accordance with an embodiment of the invention. The buddy list, as more fully discussed above, is indicated at reference numeral 720. Reference numeral 730 indicates a text box that displays a conversation 740 between a buddy (e.g., remote user), and the local user of the computing device. Further, reference numeral 760 indicates a text box that is configured to receive a correspondence 750 that is input by a remote user. In one instance, the symbol “ [symbol] ” (reference numeral 780) may passively trigger one or more commands associated therewith (as more fully discussed above). In another instance, the text “ROTATE LEFT THE MISSILE LAUNCHER” (reference numeral 790) may actively instruct one or more controllable functions of the peripheral device, typically in response to indicia of commands provided to the remote user.

Turning now to FIG. 8, an illustrative screen display 800 of an exemplary user interface 810 is shown wherein transmission from the remote-user device is provided to a computing device, in accordance with an embodiment of the present invention. By way of example and not limitation, providing may be contingent upon the local user inviting or allowing the remote user to control the peripheral device. The user interface may include a title, indicated by reference numeral 860, that depicts the subject peripheral device(s) that are to be controlled. In the depicted user interface 710, two methods for controlling the peripheral device are illustrated. In one method, as indicated by reference numeral 820, a text box is rendered such that a remote user may enter instructions 830 for controlling the peripheral device. In the second method, as indicated at 840, a control area having a representation of commands are displayed at a remote-user device. Typically, the representation of commands are provided by web server embedded in the computing device. In this second embodiment, a cursor may be used to toggle the features (e.g., tilt down arrow 850) within the control area 840. For instance, movement of the cursor to, and clicking upon, the tilt down arrow 850 within the control area 840 can be translated to instructions that control the peripheral device. In the embodiment depicted, the cursor may generate pan, tilt, and fire instructions, thereby activating the corresponding functions at a USB missile launcher peripheral device.

Although the user interface 810 presented herein is adapted for a USB missile launcher control, other interfaces may be utilized having different graphics or schemes to provide features according to the controllable functions of associated peripheral devices. Further, as is understood by those of ordinary skill in the art, other interfaces may be provided that do not utilize a cursor or are used in parallel with a cursor, and that provide other ways of inputting instructions (e.g., keyboard, touch-screen, joystick, and the like). Further, although the user interface 810 displays features in a control area 840 for controlling the functions of the peripheral device, other methods for generating instructions can be provided. Alternative user interfaces may include, for example, fully text-based or partially menu-driven embodiments rather than including a graphical component.

In one embodiment, the remote-user device is connected to a network, such as the Internet, and may be equipped with an “internet browser” (e.g., Netscape Navigator, Internet Explorer, etc.). Those or ordinary skill in the art will understand and appreciate that an internet browser, depending on the remote control device and its configuration, will differ; as such, the user interface may differ accordingly and references to the user interface are not meant to limited to the user interface 810. Further, the remote-user device may be configured to present a representation of commands, for instance, at a user interface associated with one or more commands of the command manifest. In one aspect of the invention, presentation may comprise displaying a graphical representation of the commands (e.g., icon, a pictogram, a symbol, alphanumeric character(s), bitmapped graphics, or the like) as received from the remote-user device. However, it will be understood and appreciated by those of ordinary skill in the art that methods for presenting a representation of commands are not limited to the embodiments described herein and that presentation may vary accordingly.

As can be seen from the above, embodiments of the present invention provide computerized methods and systems for providing control of a peripheral device on a computing device by a remote user. Upon receiving a communication from the peripheral device, the computing device recognizes the peripheral device (e.g., a remote-control web camera that adjusts, an automated robot that produces sound, or a unit that emits light). In one instance, the peripheral device communicates with the computing device via a universal serial bus (USB) port. A command manifest is automatically generated upon recognizing the peripheral device. The command manifest includes one or more commands that correspond to the controllable functions of the recognized peripheral device (e.g., commands that pan, tilt, and focus the remote-control web camera). The command manifest may then be communicated to the remote-user device. The remote-user device is configured to present the commands to a remote user, typically, by displaying a representation of the commands at a user interface on the remote-user device. Next, a transmission may be received from the remote-user device, where the transmission may include content that indicates one or more of the commands included in the command manifest. Content may include instructions from a remote user for controlling the peripheral device. The one or more commands that are determined from content are transferred to the peripheral device, which executes the corresponding controllable functions (e.g., causing the remote-control web camera to tilt up and pan right).

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for remotely controlling one or more peripheral devices associated with a computing device, the method comprising:
receiving a communication from a peripheral device;
accessing a command manifest associated with the peripheral device;
wherein the command manifest includes one or more commands each corresponding to at least one controllable function of the peripheral device; and
communicating the command manifest to a remote-user device.

2. The one or more computer-readable media of claim 1, further comprising receiving instructions from the remote-user device, the instructions corresponding with at least one of the one or more commands communicated in association with the command manifest.

3. The one or more computer-readable media of claim 2, wherein the method further comprises transferring the one or more commands corresponding with the received instructions to the peripheral device, and wherein the peripheral device is configured to execute the at least one controllable function corresponding with the one or more commands.

4. The one or more computer-readable media of claim 1, wherein communicating the command manifest comprises displaying, at a user interface, at a user interface associated with the remote-user device, a representation of the one or more commands.

5. The one or more computer-readable media of claim 2, wherein receiving instructions comprises receiving instructions via an instant-messaging application associated with the remote-user device and the computing device.

6. The one or more computer-readable media of claim 2, wherein the method further comprises:
determining whether the remote-user device is registered as associated with an authorized user; and
if the remote-user device is determined to be registered, communicating the one or more commands to the peripheral device.

7. The one or more computer-readable media of claim 2, wherein receiving the instructions comprises:
providing the remote-user access to an embedded web server associated with the computing device, the remote-user device being configured to present the one or more commands at a user interface; and
receiving an indication to perform the one or more commands.

8. The one or more computer-readable media of claim 2, wherein the method further comprises permitting a user associated with the remote-user device to control the at least one controllable function of the peripheral device.

9. The one or more computer-readable media of claim 1, wherein the peripheral device communicates with the computing device via a universal serial bus (USB) port.

10. The one or more computer-readable media of claim 1, wherein accessing the command manifest associated with the peripheral device comprises:
reading a programming model from the peripheral device, wherein the programming model exposes a description of the at least one controllable function;
and
mapping the at least one controllable function to the one or more commands of the command manifest.

11. The one or more computer-readable media of claim 1, further comprising receiving instructions from the remote-user device, the instructions being indicative of the one or more commands without express user interaction.

12. The one or more computer-readable media of claim 5, wherein the instant-messaging application includes access control configured to limit unauthorized remote users from controlling the at least one controllable function of the peripheral device.

13. A computer system for providing a remote user control of a peripheral device, the system comprising:
a peripheral device detecting module configured to receive communications from a plurality of peripheral devices and the determine if received communications are associated with a recognized peripheral device;
a command manifest generating module configured to automatically generate a command manifest associated with any recognized peripheral device; wherein the command manifest includes one or more commands each corresponding to at least one controllable function of the peripheral device; and
a command communicating module configured to communicate the command manifest.

14. The computer system of claim 13, further comprising a receiving module configured to receive instructions from the remote-user device, the instructions corresponding with at least one of the one or more commands communicated in association with the command manifest.

15. The computer system of claim 13, further comprising a transferring module configured to transfer the one or more commands corresponding with the received instructions to the peripheral device.

16. The computer system of claim 13, further comprising a determining module configured to determine whether the remote-user device is registered as associated with an authorized user; wherein if it is determined that the remote-user device is registered as associated with an authorized user, the command communicating module is further configured to communicate the one or more commands to the peripheral device.

17. The computer system of claim 16, further comprising an access providing module configured to provide the remote-user device access to an embedded web server associated with the computing device, the remote user-device being configured to present the one or more commands at a user interface, wherein the receiving module is further configured to receive an indication to perform the one or more commands.

18. One or more computer-readable storage media having computer-executable instructions embodied thereon that, when executed, perform a method for presenting a user interface on a remote-user device, the user interface for controlling one or more functions of a peripheral device in communication with a computing device, the user interface comprising:
code for recognizing the peripheral device, incident to receiving an indication communication there from;
code for accessing a command manifest associated with the recognized peripheral device; wherein the command manifest comprises one or more commands that correspond to one or more controllable functions of the peripheral device; and
code for communicating the command manifest to a remote-user device, wherein the remote-user device is configured to present at the user interface a representation of the one or more commands to a remote user.

19. The one or more computer-readable storage media of claim 18, wherein the code for communicating the command manifest to a remote-user device comprises code for communicating the command manifest in a format readable by an instant-messaging application associated therewith.

20. The one or more computer-readable storage media of claim 18, wherein the code for communicating the command manifest to a remote-user device comprises code for communicating the command manifest from an embedded web server associated with the computing device.
